(19) United States
(12) Patent Application Publication
(10) Pub. No.: US 2026/0226686 A1
(43) Pub. Date: Aug. 6, 2026

(54) COMPOSITE PAPERS AND METHODS OF MAKING THEREOF

(71) Applicant: EASTMAN CHEMICAL (CHINA) CO., Shanghai (CN)

(72) Inventors: Rui Xie, Pearland, TX (US); Alain Michel Cagnard, Kingsport, TN (US); Soumendra Kumar Basu, Jonesborough, TN (US); Juan Juan Wu, Pudong New District (CN)

(73) Assignee: Eastman Chemical (China) Co., Shanghai (CN)

(21) Appl. No.: 19/154,817

(22) PCT Filed: Feb. 5, 2024
(86) PCT No.: PCT/CN2024/075924

§ 371 Date: Aug. 8, 2025

Related U.S. Application Data
(60) Provisional application No. 63/484,203, filed on Feb. 10, 2023.

(51) Int. Cl. D21H 19/52; D21H 19/20

(52) U.S. Cl. CPC D21H 19/52; D21H 19/20

(57) ABSTRACT

A composite paper comprising: a paper substrate having a top surface and a bottom surface; and a coating layer on at least a portion of the top surface of the paper substrate; wherein the coating layer is formed from a composition comprising: a cellulose ester resin, and at least one organic solvent; wherein a difference between the refractive index of the paper substrate and the refractive index of the at least one cellulose ester resin is less than 0.035

### TECHNICAL FIELD

Embodiments of the present disclosure generally relate to composite papers and method of making same, and more particularly, relate to composite papers having improved light transmission.

### BACKGROUND

Paper boards are widely used in packaging applications. For example, paper folding boxes are extremely popular in secondary packaging of cosmetics, jewelries, and other luxury consumer goods, such as wines. In addition to conventional packaging, high-end packaging emphasizes the need to communicate with consumers on brand value and quality, thereby improving brand recognition and consumer loyalty. It may be highly desirable to have at least one side of a paper folding box be transparent, allowing consumers to see through and experience the design of the primary containers without the need to open up the boxes. To achieve the desired effect, conventional packaging, such as gift boxes, often consist of a window that is made of plastic film. The plastic window is usually transparent, allowing consumers to observe the primary packaging without opening up the box. However, due to incorporation of the plastic window, the box itself is not considered to be recyclable by the paper industry. In addition, the incorporation of a plastic window also makes the box harder to be composable or biodegradable. As a result, there is a need to have a paper box that is recyclable and potentially composable or biodegradable per the paper industry standard while at the same time, allows consumers to experience the design of the primary packaging.

Accordingly, there remains a need for a composite paper for use in the packaging of high-end consumer goods, such as secondary packaging for cosmetics and jewelry that provides improved light transmission and clarity while enabling recycling, composting, and biodegrading of the packaging.

### SUMMARY

Disclosed in embodiments herein are composite papers. The composite papers comprise a paper substrate having a top surface and a bottom surface; and a coating layer on at least a portion of the top surface of the paper substrate; wherein the coating layer is formed from a composition comprising: a cellulose ester resin, and at least one organic solvent; wherein a difference between the refractive index of the paper substrate and the refractive index of the at least one cellulose ester resin is less than 0.035.

Also disclosed in embodiments herein are methods of manufacturing composite papers. The methods comprise: providing a paper substrate having a top surface and a bottom surface; coating at least a portion of the top surface of the paper substrate with a composition, wherein the composition comprises a cellulose ester resin, and at least one organic solvent; and drying the composition to form a coating layer; wherein a composite paper is thereby formed having a difference between the refractive index of the paper substrate and the refractive index of the at least one cellulose ester resin is less than 0.035.

Further disclosed in embodiments herein are methods of manufacturing composite papers. The methods comprise: providing a paper substrate having a top surface and a bottom surface; providing the coating layer, wherein the coating layer is formed from a composition comprising a cellulose ester resin, and at least one organic solvent; and laminating at least a portion of the top surface of the paper substrate with the coating layer to form a composite paper; wherein a difference between the refractive index of the paper substrate and the refractive index of the at least one cellulose ester resin is less than 0.035.

Further disclosed in embodiments herein are articles made from composite papers. The articles comprise a composite paper, wherein the composite paper comprises a paper substrate having a top surface and a bottom surface; and a coating layer on at least a portion of the top surface of the paper substrate; wherein the coating layer is formed from a composition comprising: a cellulose ester resin, and at least one organic solvent; wherein a difference between the refractive index of the paper substrate and the refractive index of the at least one cellulose ester resin is less than 0.035. In one or more embodiments herein, the articles are recyclable, compostable, or biodegradable. Recyclability, compostability, or biodegradability may be determined per the standards set by the paper industry.

Additional features and advantages of the embodiments will be set forth in the detailed description which follows, and in part will be readily apparent to those skilled in the art from that description or recognized by practicing the embodiments described herein. It is to be understood that both the foregoing and the following description describe various embodiments and are intended to provide an overview or framework for understanding the nature and character of the claimed subject matter.

### DETAILED DESCRIPTION

Reference will now be made in detail to embodiments of composite papers, and methods of manufacturing thereof. The composite papers described herein may be used in the packaging of high-end consumer goods, such as cosmetics and jewelry. It is noted, however, that this is merely an illustrative implementation of the embodiments disclosed herein. The embodiments are applicable to other technologies that are susceptible to similar problems as those discussed above. For example, the composite papers described herein may be used in other packaging applications, such as, food, pharmaceuticals, or electronics, or used to make articles, such as, labels, tags, signs, or posters, all of which are within the purview of the present embodiments.

In embodiments herein, the composite paper comprises a paper substrate and a coating layer on at least a portion of the top surface of the paper substrate. The paper substrate has a top surface and a bottom surface, and may be tracing paper, writing paper, bond paper, text paper, cover paper, kraft paper, security paper, or paper board. As used herein, tracing paper may encompass glassine paper, vellum paper, impregnated paper, and parchment paper or any paper substrate having transparent or translucent properties. The papers described herein may be obtained from pulp fibers forming a fibrous substrate into a thin planar element. In some embodiments, the paper substrate is selected from the group consisting of tracing paper, writing paper, bond paper, text paper, cover paper, kraft paper, security paper, or paper board.

In one or more embodiments described herein, the paper substrate has a refractive index of at least 1.40. All individual values and subranges are included and disclosed herein. For example, in some embodiments, the paper substrate has a refractive index ranging from a lower value of 1.40, 1.42, 1.45 or 1.47 to an upper value of 1.65, 1.60, 1.55, 1.50, or 1.48. In other embodiments, the paper substrate has a refractive index of from 1.42 to 1.60, 1.45 to 1.55, or 1.45 to 1.50.

The coating layer is formed from a composition comprising a cellulose ester resin and at least one organic solvent. The composition may comprise from 1 to 40 wt. % of cellulose ester resin and from 60 to 99 wt. % of at least one organic solvent. All individual values and subranges are included and disclosed herein. For example, in some embodiments, the composition may comprise from a lower limit of 1, 3, or 5 wt. % to an upper limit of 40, 37, 35, 30, or 25 wt. % of cellulose ester resin and from a lower limit of 60, 63, 65, 70, or 75 wt. % to an upper limit of 99, 97, or 95 wt. % of at least one organic solvent.

In one or more embodiments herein, the cellulose ester resin may be selected from the group consisting of cellulose acetate resins, cellulose acetate butyrate resins, cellulose acetate propionate resins, and combinations thereof. In one or more embodiments herein, the cellulose ester resin may be selected from the group consisting of cellulose acetate butyrate resins, cellulose acetate propionate resins, and combinations thereof.

In one or more embodiments herein, the cellulose ester resin may have a ball drop viscosity of less than 3.0 seconds, as measured according to ASTM D1343. All individual values and subranges are included and disclosed herein. For example, in some embodiments, the cellulose ester resin may have a ball drop viscosity of less than 2.75, 2.5, 2.0 or 1.5 seconds. In other embodiments, the cellulose ester resin may have a ball drop viscosity ranging from 0.2, 0.5, or 1.0 seconds to less than 3.0, 2.5, or 2.0 seconds, as measured according to ASTM D1343.

In one or more embodiments herein, the cellulose ester resin may have a refractive index of at least 1.40. All individual values and subranges are included and disclosed herein. For example, in some embodiments, the cellulose ester resin has a refractive index ranging from a lower value of 1.40, 1.42, 1.45 or 1.47 to an upper value of 1.65, 1.60, 1.55, 1.50, or 1.48. In other embodiments, the cellulose ester resin has a refractive index of from 1.42 to 1.60, 1.45 to 1.55, or 1.45 to 1.50.

In one or more embodiments herein, a difference between the refractive index of the paper substrate and the refractive index of the at least one cellulose ester resin is less than 0.035. All individual values and subranges are included and disclosed herein. For example, in some embodiments, the difference between the refractive index of the paper substrate and the refractive index of the at least one cellulose ester resin is less than 0.030, less than 0.0275, or less than 0.025.

In one or more embodiments herein, the at least one organic solvent is selected from the group consisting of esters, alcohols, ketones, glycol ethers, glycol ether esters, hydrocarbons, and combinations thereof. Exemplary ester organic solvents may include, but are not limited to 2-EH acetate, decyl acetate, diethyl carbonate, dimethyl carbonate, EG acetate, ethyl lactate, heptyl acetate, hexyl acetate, isobutyl acetate, isobutyl isobutyrate, isopropyl acetate, methyl acetate, n-butyl propionate, n-pentyl propionate, ethyl acetate, n-propyl acetate, octyl acetate, p-amyl acetate, propylene carbonate, sec-butyl acetate, T-butyl acetate, n-butyl acetate, or combinations thereof. Exemplary alcohols may include, but are not limited to 2-ethyl hexanol, amyl alcohol, benzyl alcohol, cyclohexanol, diacetone alcohol, diisobutyl carbinol, ethanol, furfuryl alcohol, hexyl alcohol, isobutyl alcohol, isopropyl alcohol, methyl alcohol, methyl amyl carbinol, methyl isobutyl carbinol, n-butyl alcohol, n-propyl alcohol, sec-butyl alcohol, t-butyl alcohol, or combinations thereof. Exemplary ketones may include, but are not limited to methyl ethyl ketone, acetone, butyrolactone, cyclohexanone, cyclopentanone, diisobutyl ketone, isophorone, mesityl oxide, methyl amyl ketone, methyl isobutyl ketone, methyl isopropyl ketone, methyl n-butyl ketone, methyl propyl ketone, n-butyl pyrrolidone, n-ethyl pyrrolidone, n-methyl-2-pyrrolidone, or combinations thereof. Exemplary glycol ethers may include, but are not limited to, 1,2-dimethoxyethane, ethylene glycol phenyl ether, propylene glycol phenyl ether, dipropylene glycol methyl ether, dipropylene n-butyl ether, diethylene glycol monobutyl ether acetate, diethylene glycol monoethyl ether acetate, diethylene glycol monopropyl ether acetate, ethylene glycol 2-ethylhexyl ether, ethylene glycol monobutyl ether, ethylene glycol monopropyl ether, propylene glycol monomethyl ether acetate, ethylene glycol monoethyl ether, ethylene glycol monomethyl ether, ethylene glycol hexyl ether, propylene glycol n-butyl ether, propylene glycol n-propyl ether, propylene glycol t-butyl ether, tripropylene glycol methyl ether, tripropylene glycol n-butyl ether, propylene glycol monomethyl ether, or combinations thereof. Exemplary glycol ether esters may include, but are not limited to, propylene glycol methyl ether acetate, diethylene glycol monobutyl ether acetate, diethylene glycol monoethyl acetate, ethylene glycol monobutyl ether acetate, ethyl 3-ethoxypropionate, propylene glycol methyl ether acetate, ethylene glycol monoethyl ether acetate, or combinations thereof. Exemplary hydrocarbons may include, but are not limited to, cyclohexane, n-heptane, n-hexane, n-octane, ethyl benzene, toluene, xylene, or combinations thereof.

In one or more embodiments herein, the at least one organic solvent is an organic solvent mixture of a first organic solvent having a boiling point temperature of greater than or equal to 90° C. and a second organic solvent having a boiling point temperature less than 90° C. All individual values and subranges are included and disclosed herein. For example, in some embodiments, the at least one organic solvent is an organic solvent mixture of a first organic solvent having a boiling point temperature ranging from a lower limit of 90, 95, 100, or 105° C. to an upper limit of 150, 145, 140, 135, or 130° C. and a second organic solvent having a boiling point temperature ranging from a lower limit of 40, 50, 55, or 60° C. to an upper limit of less than 90, 87, or 85° C. Boiling point may be measured according to the Thiele Tube Method that is commonly used and familiar to those skilled in the art.

In one or more embodiments herein, the organic solvent mixture comprises at least 5 wt. % of the first organic solvent. All individual values and subranges are included and disclosed herein. For example, in some embodiments, the organic solvent mixture may comprise from a lower limit of 5, 7.5, or 10 wt. % to an upper limit of 60, 55, 50, 45, or 40 wt. % of the first organic solvent. In other embodiments, the organic solvent mixture may comprise from 5 wt. % to 60 wt. % or from 5 wt. % to 50 wt. % of the first organic solvent.

In one or more embodiments herein, the composition may further comprise a thermoplastic acrylic resin. Examples of thermoplastic acrylic resins may include, but are not limited to, alkyl (meth)acrylic resins, alkyl (meth)acrylate resins, styrene (meth)acrylic resins, styrene (meth)acrylate resins, vinyl acetate (meth)acrylic resins, vinyl acetate (meth)acrylate resins, or mixtures thereof. Exemplary thermoplastic acrylic resins that may be commercially available include, but are not limited to, NEOCRYL™ B-814, NEOCRYL™ B-805, NEOCRYLM B-817, DEGALAN™ N 742 N, DIANAL™ BR-106, and the like. In one or more embodiments herein, the composition may comprise up to 25 wt. % of thermoplastic acrylic resin. All individual values and subranges are included and disclosed herein. For example, in some embodiments, the composition may comprise from a lower limit of 0, 1, 5, 7, or 10 wt. % to an upper limit of 25, 20 or 15 wt. % of thermoplastic acrylic resin.

In one or more embodiments herein, the composite paper may exhibit one or more of the following properties: a haze value of less than 90%, as measured according to ASTM D1003; a total transmission value of at least 80%, as measured according to ASTM D1003; and/or a transmitted parallel and narrow angle light value of greater than 4%, as measured according to ASTM D1003. All individual values and subranges are included and disclosed herein. For example, in some embodiments, the composite paper may exhibit one or more of the following properties: wherein the haze value ranges from a lower limit of 20, 30, or 40% to an upper limit of 90, 87.5, or 85% as measured according to ASTM D1003; the total transmission value ranges from a lower limit of 80 to an upper limit of 95%, as measured according to ASTM D1003; and/or a transmitted parallel and narrow angle light value ranges from a lower limit of greater than 4% to an upper limit of 85, 75, 50, or 35%, as measured according to ASTM D1003.

Also disclosed in embodiments described herein are methods of manufacturing the composite papers as previously described herein. In some embodiments, the method comprises providing the paper substrate having a top surface and a bottom surface; coating at least a portion of the top surface of the paper substrate with the composition; and drying the composition to form a coating layer; wherein a composite paper is thereby formed. In other embodiments, the method comprises providing the paper substrate having a top surface and a bottom surface; providing the coating layer; and laminating at least a portion of the top surface of the paper substrate with the coating layer to form a composite paper. Conventional coating techniques may be used, including continuous as well as dip coating procedures, to form the coating layer. The composition may be applied to have a coating layer dry thickness of from about 0.5 to about 8 microns. The coating layer can be dried at a temperature of from about 20 to about 200° C. While ambient temperatures of 20° C. may require drying times of several hours, elevated temperatures, such as, 150° C. will dry the coatings in less than a few minutes. The coating layer may, if desired, be subjected to a chemical or physical surface-modifying treatment to improve the bond between the coating layer and the paper substrate.

### Test Methods

### Refractive Index

Refractive index is measured at room temperature about 20° C. according to ASTM D542 on film or paper specimens about 1″×1″ in size and 30-50 mil in thickness.

### Light Transmission

Light transmission of paper substrates and paper composites is measured according to ASTM D1003. The total light transmission Tt consists of light transmitted, but scattered at angles greater than 2.5 degrees related to the incident light (diffuse luminous transmission (Ta)), and light transmitted parallel to the incident light (Tp) and light transmitted but scattered within 2.5 degrees related to the incident light (TN). Haze of a specimen is defined as a ratio of Ta over Tt, percentage of light passing through the specimen deviates from the incident beam greater than 2.5 degree on the average.

### EXAMPLES

The following specific examples are given to illustrate the performance properties associated with paper composites.

TABLE 1
Raw Materials

| Material/Name | Description |
|---|---|
| CAP 482-0.5 | cellulose acetate propionate resin available from |
| | Eastman Chemical Co. (Kingsport, TN). |
| CAP 504-0.2 | cellulose acetate propionate resin available from |
| | Eastman Chemical Co. (Kingsport, TN). |
| ENSURE ™ | cellulose acetate butyrate resin available from Eastman |
| 100 | Chemical Co. (Kingsport, TN). |
| ethyl acetate | organic solvent available from Eastman Chemical |
| | Company (Kingsport, TN). |
| n-propyl | organic solvent available from Sigma-Aldrich (St. |
| acetate | Louis, MO). |
| butyl acetate | organic solvent available from Sigma-Aldrich (St. |
| | Louis, MO). |
| isopropanol | organic solvent available from Sigma-Aldrich (St. |
| | Louis, MO). |
| methyl ether | organic solvent available from Sigma-Aldrich (St. |
| ketone | Louis, MO). |
| propylene glycol | organic solvent available from Sigma-Aldrich (St. |
| monomethyl ether | Louis, MO). |
| Tracing Paper 70 | 70 g/m2 tracing paper available from Canson SAS |
| | (Annonay, France) |
| Tracing Paper 90 | 90 g/m2 tracing paper available from Canson SAS |
| | (Annonay, France) |
| Copy Paper | 75/m² copy paper available from Staples, Inc. (Aurora, |
| | CO) |

TABLE 2
Refractive Index of Cellulose Ester Resins and Tracing Paper

| | Refractive Index |
|---|---|
| CAP 482-0.5 | 1.475 |
| CAP 504-0.2 | 1.455 |
| ENSURE ™ 100 | 1.475 |
| Tracing Paper 70 | 1.45~1.50 |
| Tracing Paper 90 | 1.45~1.50 |

TABLE 3
Boiling Point Temperature of the Solvents*

| | Boiling Point, ° C. |
|---|---|
| ethyl acetate | 77.1 |
| n-propyl acetate | 102.0 |
| butyl acetate | 126.0 |
| isopropanol | 82.5 |
| methyl ether ketone | 79.6 |
| propylene glycol monomethyl ether | 120.0 |

*information supplied on technical data sheets.

The exemplary formulations are prepared as follows:

### Inventive Example 1

5 grams of CAP 504-0.2 is dissolved in a mixture of 85.5 grams of methyl ether ketone and 9.5 grams of butyl acetate in a glass container. A 4-inch by 4-inch sample of Tracing Paper 70 is then immersed in the solution for 30 seconds, removed from the solution, and allowed to dry at room temperature for about 60 seconds. After further drying in an oven set to 90° C. for about 90 seconds, a composite paper with both sides coated is obtained. The composite paper is evaluated for light transmission. Results are listed in Table 4.

### Inventive Example 2

5 grams of ENSURE™ 100 is dissolved in a mixture of 30.0 grams of ethyl acetate, 22.0 grams of propyl acetate, 11.5 grams of isopropanol, 20.0 grams of methyl ether ketone and 11.5 grams of butyl acetate in a glass container. A 4-inch by 4-inch Tracing Paper 70 is then immersed in the solution for 30 seconds, removed from the solution, and allowed to dry at room temperature for about 60 seconds. After further drying in an oven set to 90° C. for about 90 seconds, a composite paper with both sides coated is obtained. The composite paper is evaluated for light transmission. Results are listed in Table 4.

### Inventive Example 3

5 grams of CAP 504-0.2 is dissolved in a mixture of 85.5 grams of methyl ether ketone and 9.5 grams of butyl acetate in glass container #1, and 15 grams of CAP 504-0.2 is dissolved in a mixture of 72.25 grams of methyl ether ketone and 12.75 grams of butyl acetate in glass container #2. A 4-inch by 4-inch Tracing Paper 70 is then immersed in the solution in container #1 for 30 seconds, removed from the solution, and allowed to dry at room temperature for about 60 seconds. After further drying in an oven set to 90° C. for about 90 seconds, the paper is immersed in container #2 for 30 seconds, removed from the solution, and allowed to dry at room temperature for about 60 seconds. After further drying in an oven set to 90° C. for about 90 seconds, a composite paper is obtained. The composite paper is evaluated for light transmission. Results are listed in Table 4.

### Inventive Example 4

5 grams of ENSURE™ 100 is dissolved in a mixture of 30.0 grams of ethyl acetate, 22.0 grams of propyl acetate, 11.5 grams of isopropanol, 20.0 grams of methyl ether ketone and 11.5 grams of butyl acetate in glass container #1. 20 grams of ENSURE™ 100 is dissolved in a mixture of 25.0 grams of ethyl acetate, 19.0 grams of propyl acetate, 9.5 grams of isopropanol, 17.0 grams of methyl ether ketone and 9.5 grams of butyl acetate in glass container #2. A 4-inch by 4-inch Tracing Paper 70 is then immersed in the solution in Container #1 for 30 seconds, removed from the solution, and allowed to dry at room temperature for about 60 seconds. After further drying in an oven set to 90° C. for about 90 seconds, the paper is immersed in the solution in container #2 for 30 seconds, removed from the solution, and allowed to dry at room temperature for about 60 seconds. After further drying in an oven set to 90° C. for about 90 seconds, a composite paper with both sides coated is obtained. The composite paper is evaluated for light transmission. Results are listed in Table 4.

### Inventive Example 5

15 grams of CAP 504-0.2 is dissolved in a mixture of 20.0 grams of ethyl acetate, 15.0 grams of propyl acetate, 15.0 grams of isopropanol, 25.0 grams of methyl ether ketone and 10.0 grams of propylene glycol monomethyl ether in a glass container. A 4-inch by 4-inch Tracing Paper 70 is then immersed in the solution for 30 seconds, removed from the solution, and allowed to dry at room temperature for about 60 seconds. After further drying in an oven set to 90° C. for about 90 seconds, the paper is immersed in the solution again for 30 seconds, removed from the solution, and allowed to dry at room temperature for about 60 seconds. After further drying in an oven set to 90° C. for about 90 seconds, a composite paper with both sides coated is obtained. The composite paper is evaluated for light transmission. Results are listed in Table 4.

### Comparative Example 1

A 4-inch by 4-inch Tracing Paper 70 is evaluated for light transmission. Results are listed in Table 4.

### Inventive Example 6

15 grams of CAP 482-0.5 is dissolved in a mixture of 19.0 grams of ethyl acetate, 33.0 grams of propyl acetate, 4.0 grams of isopropanol, 23.0 grams of methyl ether ketone and 6.0 grams of butyl acetate in a glass container. A 4-inch by 4-inch Tracing Paper 90 is then immersed in the solution for 30 seconds, removed from the solution, and allowed to dry at room temperature for about 60 seconds. After further drying in an oven set to 90° C. for about 90 seconds, the paper is immersed in the solution again for 30 seconds, removed from the solution, and allowed to dry at room temperature for about 60 seconds. After further drying in an oven set to 90° C. for about 90 seconds, a composite paper with both sides coated is obtained. The composite paper is evaluated for light transmission. Results are listed in Table 4.

### Inventive Example 7

20 grams of ENSURE™ 100 is dissolved in a mixture of 25.0 grams of ethyl acetate, 19.0 grams of propyl acetate, 9.5 grams of isopropanol, 17.0 grams of methyl ether ketone and 9.5 grams of butyl acetate in a glass container. A 4-inch by 4-inch Tracing Paper 90 is then immersed in the solution for 30 seconds, removed from the solution, and allowed to dry at room temperature for about 60 seconds. After further drying in an oven set to 90° C. for about 90 seconds, the paper is immersed in the solution again for 30 seconds, removed from the solution, and allowed to dry at room temperature for about 60 seconds. After further drying

in an oven set to 90° C. for about 90 seconds, a composite paper with both sides coated is obtained. The composite paper is evaluated for light transmission. Results are listed in Table 4.

### Comparative Example 2

A 4-inch by 4-inch Tracing Paper 90 is evaluated for light transmission. Results are listed in Table 4.

### Inventive Example 8

15 grams of CAP 504-0.2 is dissolved in a mixture of 20.0 grams of ethyl acetate, 15.0 grams of propyl acetate, 15.0 grams of isopropanol, 25.0 grams of methyl ether ketone and 10.0 grams of propylene glycol monomethyl ether in a glass container. A 4-inch by 4-inch Copy Paper is then immersed in the solution for 30 seconds, removed from the solution, and allowed to dry at room temperature for about 60 seconds. After further drying in an oven set to 90° C. for about 90 seconds, the paper is immersed in the solution again for 30 seconds, removed from the solution, and allowed to dry at room temperature for about 60 seconds. After further drying in an oven set to 90° C. for about 90 seconds, a composite paper with both sides coated is obtained. The composite paper is evaluated for light transmission. Results are listed in Table 4.

### Comparative Example 3

A 4-inch by 4-inch Copy Paper is evaluated for light transmission. Results are listed in Table 4.

TABLE 4
Results

| | Solvent | | | | Transmitted |
|---|---|---|---|---|---|
| | Mixture | | Diffuse | | Parallel Light |
| | Relative | | Luminous | Total | (Tp) & |
| | Evaporation | | Trans- | Trans- | Transmitted |
| | Rate (Butyl | Haze, | mission | mission | Narrow Angle |
| | Acetate = 1.0) | % | (Td), % | (Tt), % | Light (Tn), % |
| IE 1 | 3.38 | 89.53 | 76.77 | 84.87 | 8.1 |
| IE 2 | 2.85 | 90.27 | 77.44 | 84.90 | 7.46 |
| IE 3 | 3.38 | 78.77 | 66.47 | 83.39 | 16.92 |
| IE 4 | 2.85 | 70.57 | 59.92 | 83.78 | 23.86 |
| IE 5 | 2.93 | 79.33 | 66.66 | 82.97 | 16.31 |
| CE 1 | | 94.94 | 76.78 | 80.07 | 3.29 |
| IE 6 | 2.76 | 77.41 | 65.29 | 83.33 | 18.04 |
| IE 7 | 2.85 | 73.46 | 61.43 | 82.56 | 21.13 |
| CE 2 | | 95.21 | 75.78 | 78.82 | 3.04 |
| IE 8 | 2.93 | 98.78 | 44.36 | 44.48 | 0.12 |
| CE 3 | | 98.81 | 19.01 | 19.06 | 0.05 |

As shown in the Tables above, the formulations of the present invention exhibit lower haze, increased total light transmission, and higher transmitted parallel light and narrow angle light as compared to the paper alone.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A composite paper comprising:
a paper substrate having a top surface and a bottom surface; and
a coating layer on at least a portion of the top surface of the paper substrate;
wherein the coating layer is formed from a composition comprising:
a cellulose ester resin, and
at least one organic solvent;
wherein a difference between the refractive index of the paper substrate and the refractive index of the at least one cellulose ester resin is less than 0.035.

2. The composite paper of claim 1, wherein the cellulose ester resin has a ball drop viscosity of less than 2.0 seconds, as measured according to ASTM D1343.

3. The composite paper of claim 1, wherein the cellulose ester resin is selected from the group consisting of cellulose acetate resins, cellulose acetate butyrate resins, cellulose acetate propionate resins, and combinations thereof.

4. The composite paper of claim 1, wherein the at least one organic solvent is selected from the group consisting of esters, alcohols, ketones, glycol ethers, glycol ether esters, hydrocarbons, and combinations thereof.

5. The composite paper of claim 4, wherein the at least one organic solvent is an organic solvent mixture of a first organic solvent having a boiling point temperature of greater than 90° C. and a second organic solvent having a boiling point temperature less than 90° C.

6. The composite paper of claim 5, wherein the organic solvent mixture comprises at least 5 wt. % of the first organic solvent.

7. The composite paper of claim 1, wherein the paper substrate is selected from the group consisting of tracing paper, writing paper, bond paper, text paper, cover paper, kraft paper, security paper, and paper board.

8. The composite paper of claim 1, wherein the coating further comprises a thermoplastic acrylic resin.

9. The composite paper of claim 1, wherein the composite paper exhibits one or more of the following properties:
a haze value of less than 90%, as measured according to ASTM D1003;
a total transmission value of at least 80%, as measured according to ASTM D1003; and/or
a transmitted parallel and narrow angle light value of greater than 4%, as measured according to ASTM D1003.

10. An article made from the composite paper of claim 1.

11. The article of claim 10, wherein the article is one or more of recyclable, compostable, or biodegradable.

12. A method of manufacturing a composite paper according to claim 1 the method comprising:
providing the paper substrate having a top surface and a bottom surface;
coating at least a portion of the top surface of the paper substrate with the composition; and
drying the composition to form a coating layer;
wherein a composite paper is thereby formed.

13. A method of manufacturing a composite paper according to claim 1, the method comprising:
providing the paper substrate having a top surface and a bottom surface;
providing the coating layer; and
laminating at least a portion of the top surface of the paper substrate with the coating layer to form a composite paper.
